(19) United States
(12) Patent Application Publication
(10) Pub. No.: US 2016/0048486 A1
(43) Pub. Date: Feb. 18, 2016

(54) MULTI-USER STREAM COLLABORATIVE DOCUMENT EDITING TOOL

(71) Applicant: R-Corporation, Dallas, TX (US)

(72) Inventor: Edward Lopategui, Dallas, TX (US)

(21) Appl. No.: 14/458,698

(22) Filed: Aug. 13, 2014

(51) Int. Cl. G06F 17/22; G06F 3/0484; G06F 17/24

(52) U.S. Cl. CPC G06F 17/2288; G06F 17/24; G06F 17/2211; G06F 3/04842

(57) ABSTRACT

A collaborative system assists multiple users to independently and collaboratively edit a document by preserving at least one revision of the document for each user. Each user may share at least one revision with another user to facilitate collaborative development of the document by merging a revision from each user into a new revision. Streams of revisions are kept separately for each user working on the document.

### TECHNICAL FIELD

Embodiments described herein generally relate to creating, editing and sharing documents to assist in collaborative development and support archival of shared documents.

### BACKGROUND ART

Within the current art, document collaboration solutions maintain revisions of shared documents at regular intervals as a single chronological continuum, but approach collaboration from two diametrically opposed philosophies: the “parallel” and “serial” models. In the parallel model, e.g. Google Docs and Microsoft Office 365™, document accessibility and speed is prioritized over integrity, such that any collaborating user in the system can edit a document at any time, perhaps even simultaneously with other users. (OFFICE 365 is a trademark of Microsoft Corporation.) Changes are instantaneously incorporated and overwrite prior edits, without seeking agreement or approval between collaborators. Revisions of the document when saved form a single chronological continuum and while changes can be wholly reverted by recalling a previous document revision, individual changes cannot be selectively reverted.

In the serial model, e.g. Microsoft Sharepoint® and Enterprise Content Management (ECM) systems, document integrity is prioritized over accessibility, such that a collaborating user must first obtain permission from the system, or “check out,” a document before editing can commence. (SHAREPOINT is a registered trademark of Microsoft Corporation.) During check out, a single user has exclusive access to the document and no other user can make edits to that document. Other users must instead wait until the document is checked back in, allowing them to subsequently check out and make additional edits. Revision history is stored as a single chronological continuum, with delineations at each check-in/check-out cycle. The check-out mechanism allows each user the time necessary to complete their changes, so they can be reasonably vetted by other users before continuing to the next batch of edits. However, such a mechanism forces each batch of user changes to be necessarily separate and distinct and consequently seriously impairs document collaboration flexibility and speed. In some systems, document decimation is used to break documents into individual components to permit more parallelism in document editing. However, document decimation only works in highly structured environments where a precise document structure is known in advance.

In contrast to document collaboration solutions, software source control systems permit multiple users to simultaneously edit, or “fork,” software code without overwriting master code, allowing multiple users to work on the same document simultaneously. Change can then be merged into a baseline at a later time. Those systems, however, are designed for plain text (i.e. code snippets) and generally have command line interfaces unsuitable for the average document author. Furthermore, because software source control places few restrictions on forking and merging capability specifically relative to user ownership, the model can become too complex for how people normally work with documents. This complexity is the main reason any attempts to overlay document revisioning systems directly on top of popular source control systems like Git have proven rather unsuccessful.

Barring universal use or access to any of these aforementioned revisioning systems, document collaborators will often resort to manual interchange of document revisions. Collaborators save their own copies of documents with different filenames, using the “save as” feature, and periodically interchange them via email, network folders, or cloud storage services. However, this manual approach frequently proves unsustainable due to the significant coordination burden on all collaborators and the propensity for error and lost document revisions.

The proliferation of methods to share and author documents has further compounded the effectiveness of all of the above solutions. Document collaboration solutions, whether parallel or serial, typically require all collaborators to operate within the same management environment. This requirement can impede access for collaborators based on the software they are using to author the document, their current location, or the programmable device being used to edit the document. For example, Google Docs users must use the Google Docs web-based word processor to author and edit their document, and any offline functionality is exclusively limited to use through Google Chrome.

There exists an unmet need to strike a measured and variable balance between accessibility of document edits for any collaborator while still maintaining deliberate change management integrity. Accomplishing this goal requires combining certain elements of the aforementioned systems in a novel fashion, and further abstracting that methodology to ease the demand on the user and maintain flexibility for documents edited on different devices, authoring software, and storage mediums.

### BRIEF DESCRIPTION OF DRAWINGS

The accompanying drawings, which are incorporated in and constitute a part of this specification, illustrate an implementation of apparatus and methods consistent with the present invention and, together with the detailed description, serve to explain advantages and principles consistent with the invention. In the drawings,

FIG. 1 is a block diagram illustrating a network of devices employed by document authors and editors, using an authoring program and the client software to edit documents and sharing documents via communication between the client software and a web service over a network.

FIGS. 2-4 is a block diagram illustrating storage of documents and revisions in repositories as multiple revisions are made and shared among users according to one embodiment.

FIG. 5 is a block diagram illustrating a document history display according to one embodiment.

FIG. 6 is a block diagram illustrating various configurations of the document history display of FIG. 5 according to one embodiment.

FIG. 7 is a block diagram illustrating collapsing a range of revisions in the document history display according to one embodiment.

FIGS. 8-9 are block diagrams illustrating a sequence of editing and sharing events according to one embodiment.

FIG. 10 is a flowchart illustrating a technique for deciding whether to save a document by overwriting the current revision or creating a new revision according to one embodiment.

FIG. 11 is a flowchart illustrating a technique for voting on whether to approve a revision as final according to one embodiment.

FIG. 12 is a block diagram illustrating a programmable device usable for implementing the disclosed techniques according to one embodiment.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

As used herein, the term “a programmable device” can refer to a single programmable device or a plurality of programmable devices working together to perform the function described as being performed on or by a programmable device. Similarly, “a machine-readable medium” can refer to a single physical medium or a plurality of media that together may store the material described as being stored on the machine-readable medium.

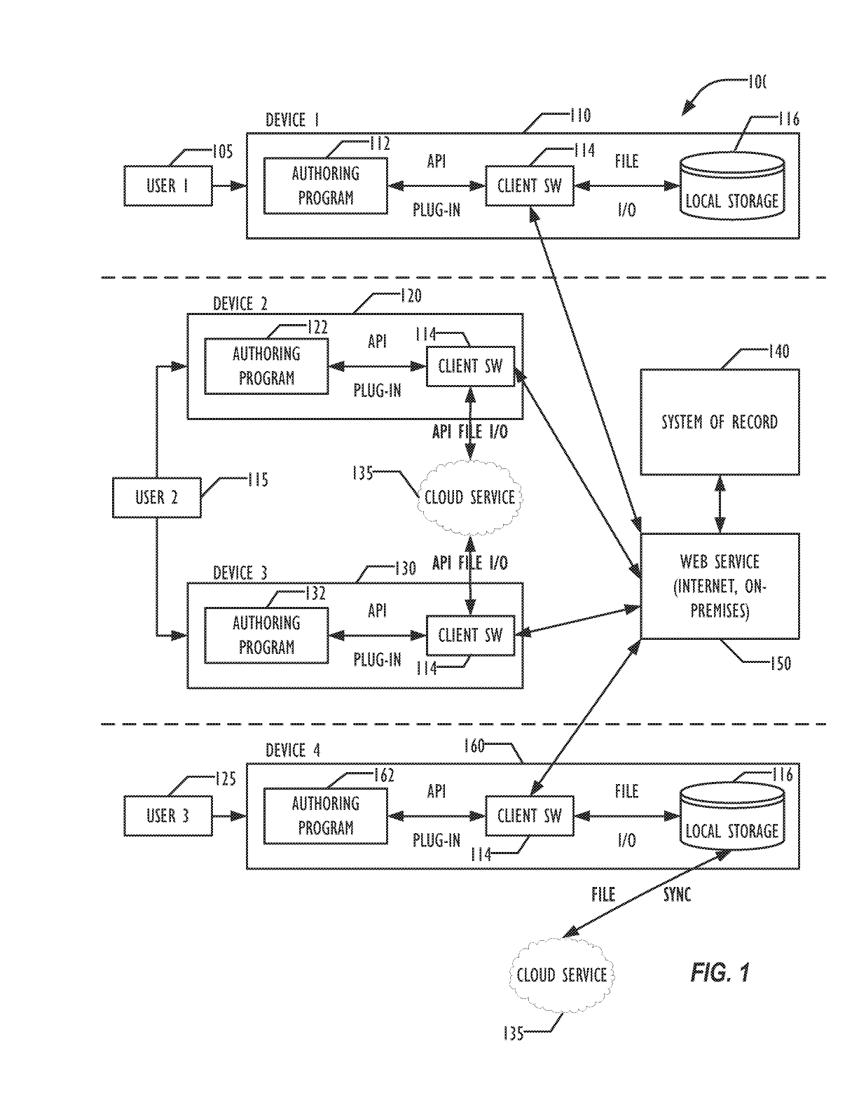

FIG. 1 is a block diagram illustrating a system 100 of programmable devices that can implement a collaborative document editing tool according to one embodiment. In this illustration, four programmable devices 110, 120, 130, and 160 provide users with access to the document through the collaborative document editing too. Any type of programmable device may be used for devices 110, 120, 130, and 160, including desktop computers, laptop computers, tablets, or smart phones and other mobile devices. A client software 114 is installed and operates on the programmable device. The client software 114 typically runs as a resident service in the background and starts with device boot, but other embodiments may run the client software 114 in the foreground or start the software at user request. The client software 114 monitors one or more file directory locations either on the corresponding device's local storage 116 (e.g., memory, hard disk, attached network drives, etc.) or on a cloud service 135 (e.g. Dropbox, Google Drive, etc.) that is also installed on and connected to the device 114. The client software 114 ignores documents in unmonitored directories. The client software may interact with a local file directory that is synchronized via the cloud service 135, or in an alternative configuration may communicate directly with the cloud service 135 via available application programming interface (API). The client software 114 also interfaces with an authoring program 112, 122, 132, 162 (e.g. word processor, spreadsheet, presentation editor, text editor, etc.) via a plug-in interface or available API. As documents are created or saved by the authoring program 112, 122, 132, 162 in the monitored location(s), the client software 114 adds new revisions as distinct copies of the document (with automatically generated filenames) to a hidden document repository in the same monitored location. The revisions are stored as complete documents that incorporate changes to a previous revision, rather than just changes to the previous revision. The client software 114 also may transmit new document revisions, selected metadata, and sharing instructions (if any) to a Web Service 150. The communication to the web service 150 or the cloud service 135 may be encrypted in some embodiments using any desired form of encryption.

The Web Service 150 is a Software as a Service (SaaS) platform available over the internet, or in an alternative configuration may be installed in an on-premises server instance for use solely within a private intranet. The web service 150 passes messages and document revisions from each client software 114 instance on specific programmable devices to coordinate and deliver those messages and document revisions to client software 114 on other programmable devices. By doing so, the web service 150 synchronizes the document repositories maintained on each programmable device 110, 120, 130, 160 with the document repositories maintained on each other programmable device 110, 120, 130, 160, creating a distributed repository that is replicated on each device 110, 120, 130, 160. In addition the web service 150 may store a global or master document repository to insure against loss or damage to any device on the system. In an alternative configuration, the web service 150 may transmit part or all of the master document repository to an archival system of record 140 either at regular intervals or when the document is marked as final. Transport to the system of record could be via direct integration (a custom bridge or API) or any other desired form of transport.

In some embodiments, policy requires that documents must ultimately be controlled or released within a system of record for the enterprise which may be an Enterprise Content Management (ECM), Product Lifecycle Management (PLM) or Enterprise Resource Planning (ERP) system capable of enforcing corporate policy or regulation relative to document retention, release, and publication. Once document collaboration has been completed, the web service 150 can transmit the completed document to the system of record 140 for further processing or permanent storage. Documents may be stored or retrieved from the system of record 140 in any desired or convenient manner.

Users 105, 115, and 125 may interact with the authoring program 112, 122, 132, or 162 using native application user interfaces, which may be augmented by the client software 114. A user such as user 115 who uses multiple programmable devices 120, 130 may have access to the same document and its various revisions on any of the multiple programmable devices 120, 130.

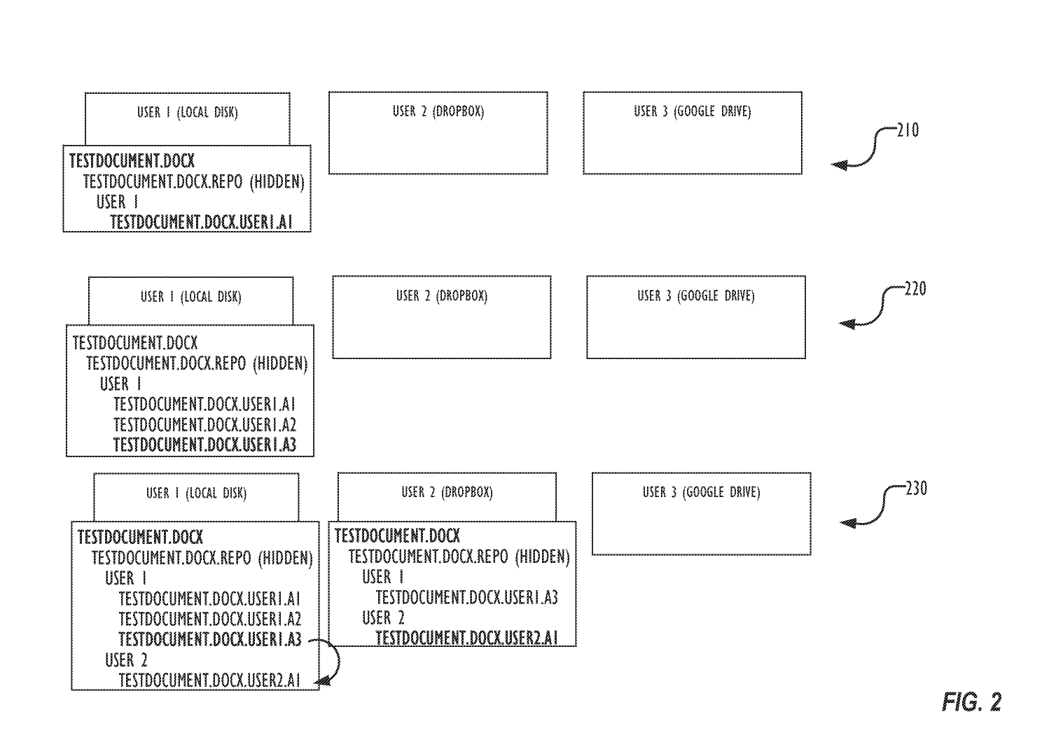

FIGS. 2-4 are block diagrams illustrating how document revisions are instanced across user repositories according to one embodiment. In each diagram, boldfaced text indicates that the file is visible to the user and the corresponding file in the hidden repository. The system 100 stores, perpetuates, and distributes document revisions among collaborating users. Each user's revisions and repositories are saved to the same storage medium the client software 114 has been configured to monitor as described above. Consequently, each user may use a different local storage location 116 or cloud service 135 and the web service 150 routes corresponding revisions to each user accordingly. Each user interacts with only a single file, and does not need to remember revision nomenclature, who the revisions belong to, nor where the specific revision is stored. The client software 114 overwrites the contents of the single file such that it always reflects the latest revision belonging to that user (i.e., the latest revision in that user's stream). Prior revisions are copied into the hidden repository and cannot be explicitly edited. When the user opens the single file in the authoring program 112, 122, 132, 162, the client software 114 automatically interprets the associated repository in the local storage 116 or cloud service 135 to provide visualization and access to all revisions across all streams for that document's history as described below. If a user opens multiple files in the authoring program 112, 122, 132, 162, the client software 114 loads the document associated with the instance of the authoring program 112, 122, 132, 162 that is currently in focus.

In one embodiment, the system 100 generates filenames for each subsequent repository revision using the following format:

<original document title>+<UserID>+<RevisionID>

where original document title is the textual descriptor chosen by the user that originated the document

where UserID is a unique identifier for the user that created the revision

where RevisionID is an alphanumeric sequence starting with A1, A2, A3 . . . . An where the “A” is a alphabetic prefix and the “n” is a numeric suffix that is incremented with each revision of the document. The alphabetic prefix is incremented and the numeric suffix is reset to 1, e.g. A3→B1, D4→E1, etc., when the user establishes a milestone revision, combines two revisions, or reverts a prior revision. Alternative embodiments may allow the specific revisionID's to be user configurable between numerals and letters, or to exclude certain characters (e.g., I, O, Q, S, X, and Z). The set of revisions for a user is called a stream. This file name format is illustrative and by way of examples, and any other desired file name format may be used. In some embodiments, the file name format is configurable.

In one embodiment, a document revision is not instanced with each user save of the document, but may be instanced only at certain save events. An autosave may be configured to occur whenever editing stops for a predetermined time, e.g., 5 or more seconds or every 5 minutes during continuous editing. In one embodiment, the revisionID is incremented via an algorithm similar to the following, which may be user configurable with variable preferences:

If current Revision is Milestone Save New Revision
Else
If Date(Today) > Date(File)+1 Day Save New Revision
Else
If Size(Current) > Size(Existing Ver) +/− 5K Save New Revision
Else
If Active Editing Time > 1 Hour Save New Revision
Else
Overwrite current revision

In FIG. 2, diagram 210 illustrates an example in which user 1 creates a document named testdocument.docx. A copy of the document is stored in the hidden repository as textdocument.docx.user1.a1. In diagram 220, user 1 has worked on the document for a time, generating two more revisions. Revision A3 is current in this example.

In diagram 230, user 1 has shared the current (A3) revision with user 2, creating a testdocument.docx.user2.a1 in user 2's repository and also in user 1's repository, as well as a copy of that revision in the monitored directory of user 2's repository. In some embodiments, the shared document is pushed from user 1 to user 2; in other embodiments, the shared document may be pulled by user 2 from user 1. A copy of user 1's A1 revision is also in user 2's repository. None of the files in either user's hidden repository are directly visible or accessible to either user, although some embodiments may allow access to revisions by the user through the system 100, which may make a revision accessible for a user by copying it from the hidden repository to the user-visible file.

In some embodiments, certain revisions in a user's stream of revisions may be selectively hidden from one or more other users. In such an embodiment, user 2's A1 revision may not be visible to user 1 and user 1's A3 revision may not be not visible to user 2. In other embodiments, all revisions by any user sharing a document may be visible to all other users sharing the document.

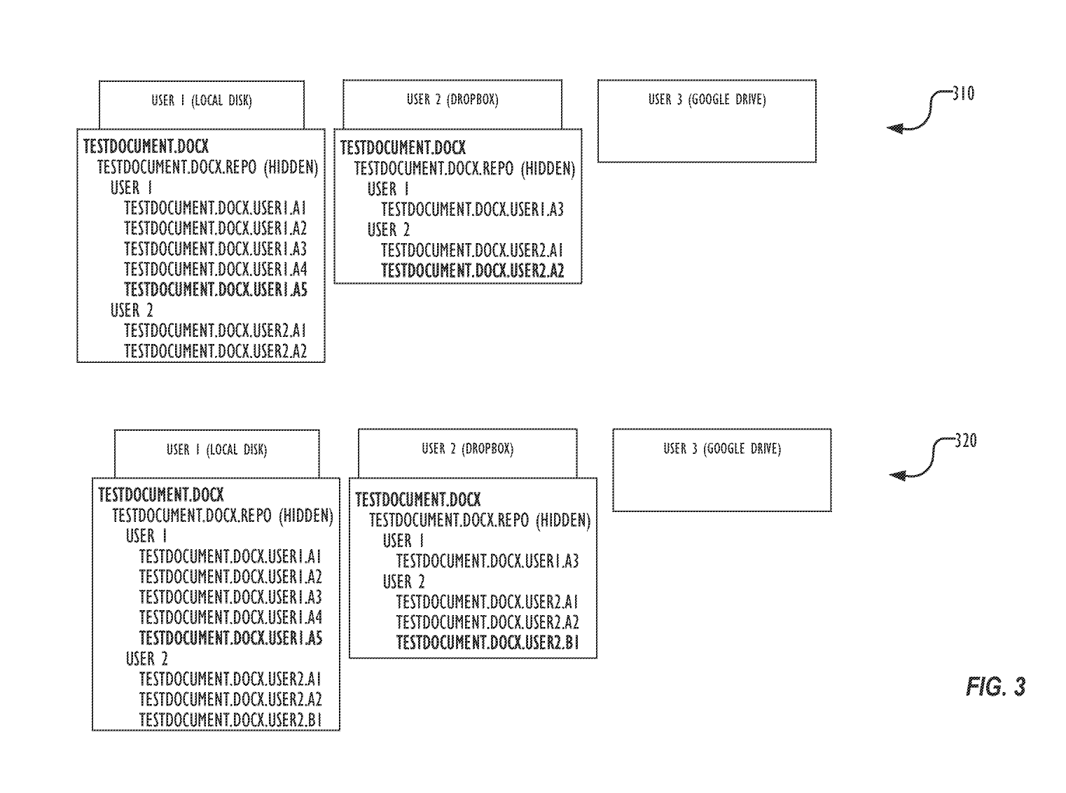

In FIG. 3, diagram 310 is a block diagram illustrating user 2 having made an additional (A2) revision, while user 1 makes 2 additional (A4 and A5) revisions. In diagram 320, user 2 marks revision A2 as a milestone, causing the creation of a milestone revision (B1) that updates the prefix B and resets the suffix to 1. This might be done when user 2 has finished making whatever changes user 2 intends to make.

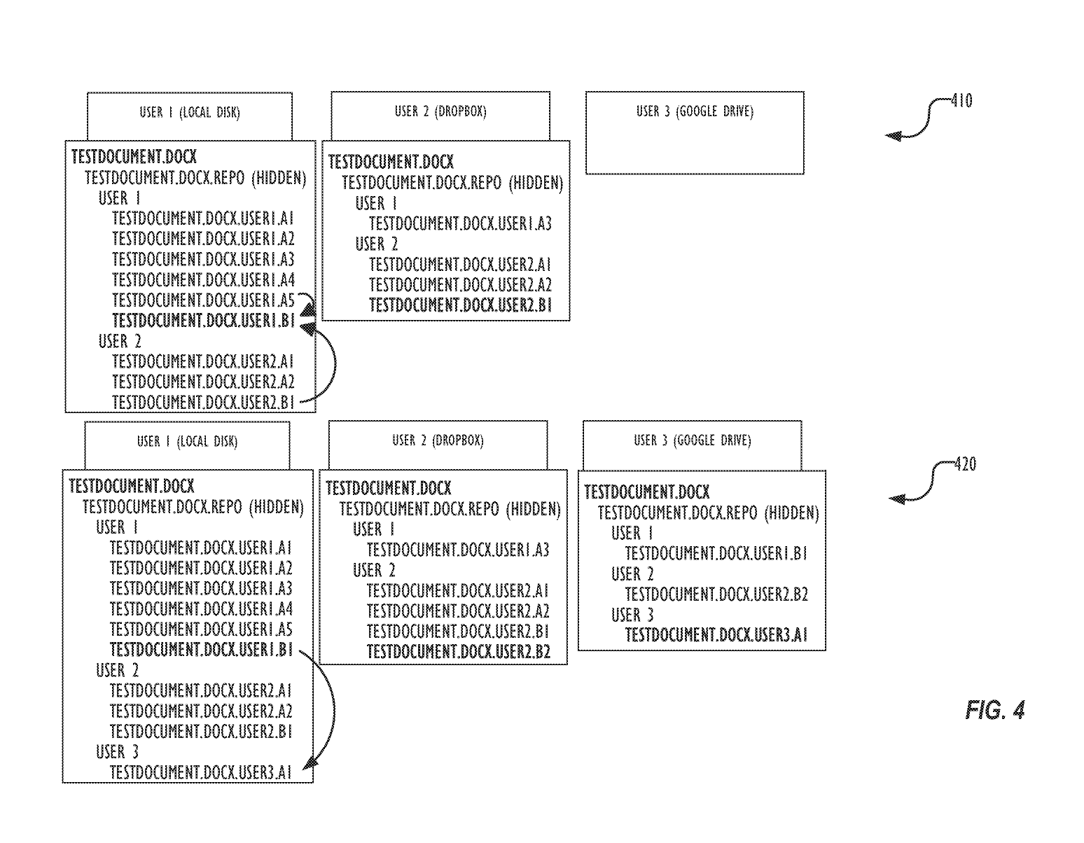

FIG. 4 includes diagram 410, which illustrates user 1 now combining user 1's A5 revision with user 2's B1 revision, creating a new milestone revision B1 for user 1. Finally, in diagram 420, user 1 shares revision B1 with user 3, while user 2 creates a new milestone revision B2.

As illustrated in diagram 420, every revision made by either user 1, user 2, or user 3 is contained in this embodiment in user 1's hidden repositories, which is synchronized with the other hidden repositories by the web service 150. In one embodiment, the repository belonging to the user who originated the document (and the repository copy on the Web Service 150 if used) contains all revisions of the document. Each successive user's repository contains revisions generated at or after the time of sharing to that user. In another embodiment, the system 100 would replicate the repositories completely, such that all users have all revisions stored in their local repositories. In another embodiment, the system would replicate only the revisions specifically authorized, or, alternatively, not specifically excluded, by the sharing user to be visible to another user, on a per-user basis. In another embodiment, each user's repository would retain revisions based on a storage limitation criteria such that as disk space for the repository is exceeded, the oldest revisions are successively dropped from the local store 116 until disk space limitations are met, although in one embodiment they could be retrieved again via the web service 150 if needed. Another embodiment, such as for a mobile device with limited local storage 116 may be configured to retain only the latest copies on the device.

In some embodiments, security measures such as encryption or passwords may be used to prevent unauthorized access to the hidden repository copies of the documents stored in that repository.

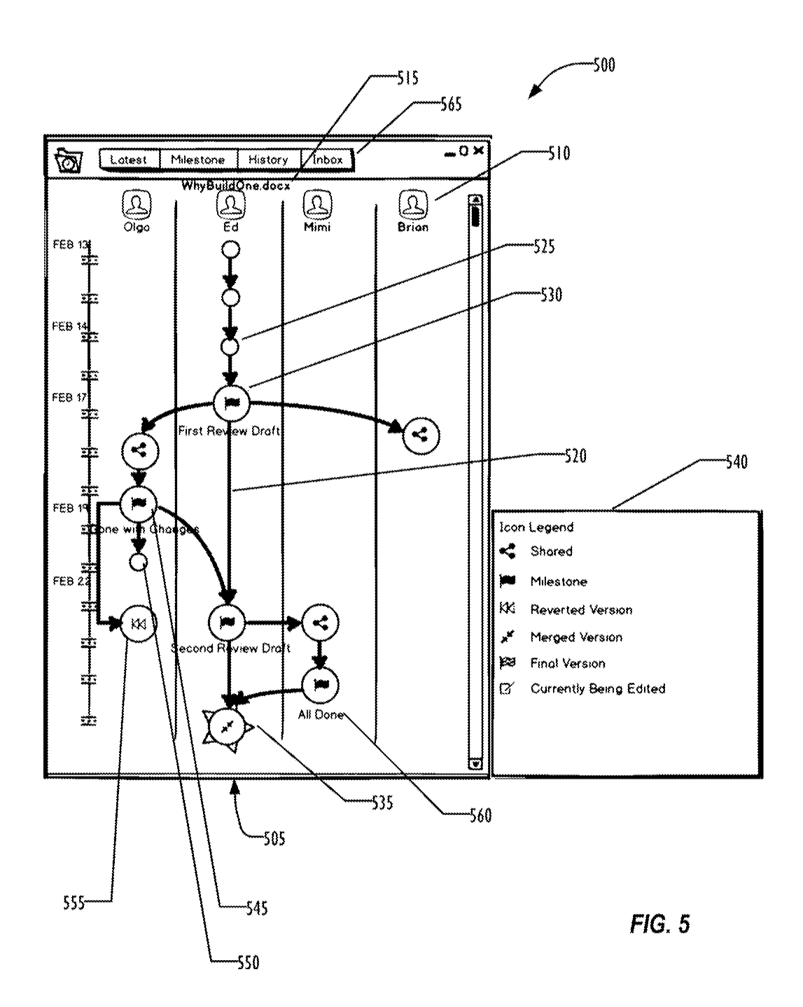

Because the system 100 is designed to use third party applications 112, 122, 132, 162 for the ordinary exercise of document editing, such as the Microsoft WORD® software (“WORD” is a registered trademark of Microsoft Corporation), the user interface of the third party application 112, 122, 132, 162 is used for editing the document. When a user opens a document in the authoring program 112, 122, 132, 162, the client software 114 accesses the repository for that document and preloads information related to each user stream for that document as a graphical interactive map. The client software 114 may display the map at user request either by a clicking on an icon (e.g., a Windows system tray icon) or through a keyboard shortcut (e.g. SHIFT-TAB). The graphical map may appear either in a separate window or may appear as an overlay or other integration within the authoring program. An example of the graphical map 500 is illustrated in FIG. 5.

The graphical map 500 represents each user document stream along a horizontal axis and modification dates along a vertical axis. The graphical map 500 in one embodiment centers around the current user's stream, displaying all of that user's revisions in a “lane” 505. Each lane is labeled in a row of icons 510 to identify the owning user. The document title 515 is also displayed at the top. Using the display, a user can understand a document's history across two dimensions simultaneously: user and time. Each revision is connected via an arrow such as arrow 520 originating from directly related preceding as well as subsequent revisions. Arrows cross lanes when revisions are shared between users or when two revisions from different users are combined. Each revision is represented by an icon, in FIG. 5 circles. Size is used to distinguish ordinary or minor revisions from special revisions, such as milestones. Smaller icons (e.g., circle 525) denote minor revisions (e.g. A2, A3, A4, etc.) while large icons (e.g., circle 530) denote major revisions, such as milestones, sharing instances, reverted revisions, combined revisions, or final revisions (e.g. A1, B1, C1, etc.). In some embodiments, a textual or graphical indication of the revisionID may be provided and associated with the revision in the visual stream. The revision currently open for editing may be visually indicated (indicated with a star 535 in the diagram 500) and relationships of the current open revision to related revisions are highlighted (such as by using a different color for the arrow line or the circles of related revisions). The map can be scrolled along both axes if the map does not fit within the screen space provided. In one embodiment, major revisions may be marked with a symbol indicating the type of revision, and a legend 540 may be provided or optionally displayed to indicate the meanings of the symbols. For example, in FIG. 5, a solid flag symbol is used to indicate a milestone revision, while a checkered flag is used to indicate a final revision. Different colors may also be used to distinguish the revisions of each user's stream from other users' streams. Lane markers may be used to separate the lanes visually if desired. The iconography of FIG. 5 is illustrative and by way of example only, and other design elements may be used for any or all of the map elements. In one embodiment, some of all of the iconography may be user configurable.

FIG. 5 also illustrates a reversion action. Revision 545 is edited to produce revision 550. Then the user decides the revision 550 is incorrect or unwanted and wishes to revert to the state of revision 545. By performing the reversion action, as described below, a copy of revision 545 is made as a new revision 555, which becomes the latest revision in that stream and is marked with a “Reverted Revision” symbol.

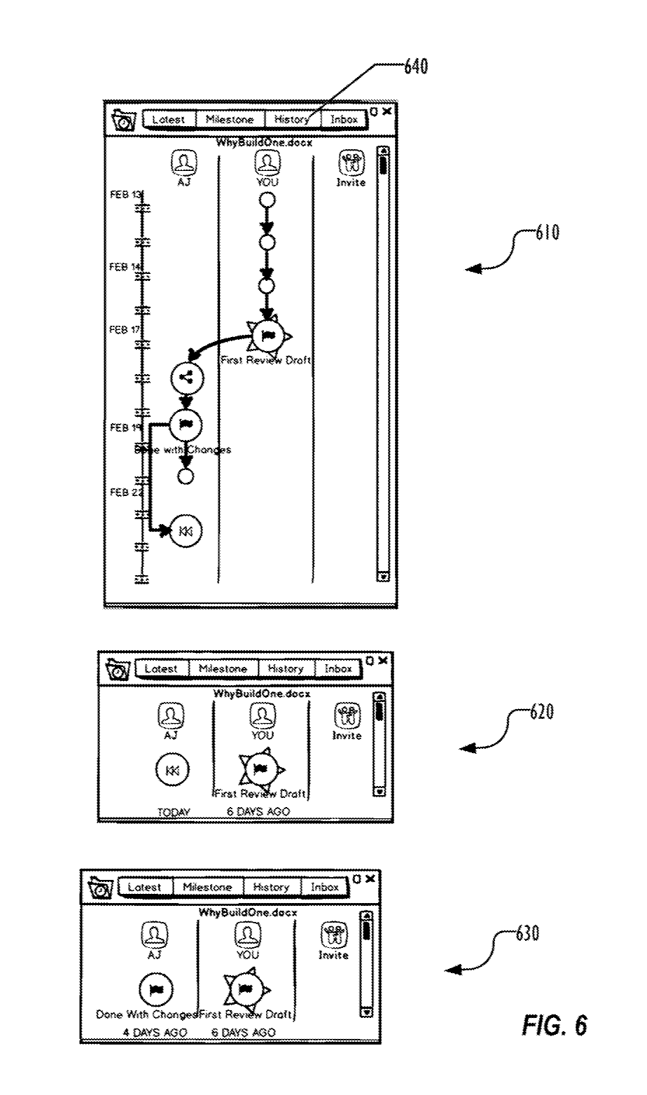

The graphical display of document revisions of FIG. 5 shows the entire history of each stream. In one embodiment, illustrated in FIG. 6, two compact views may be provided, “Latest” and “Milestone.” In one embodiment, selection of which view should be displayed may be made by selecting a button in input area 640. View 610 in FIG. 6 is the history view of FIG. 5. Both compact views show only one revision of the document for each user based on that criteria. “Latest” view 620 displays the latest revision, if any, belonging to each user and displays the date the revision was modified relative to the current day. “Milestone” view 630 displays the latest milestone, if any, for each user and displays the date the milestone was modified relative to the current day. The compact views are intended as an efficient method to keep track of the latest revisions contributed by each user. Thus in view 610, the document has been edited 4 times by user “You”, the last revision marked as a “First Review Draft” then shared with user AJ. User AJ has made two revisions, the first of which was marked as a milestone, followed by a second revision. AJ then reverted back to the first revision, with the reversion illustrated as a new revision in the stream with the reversion symbol.

In Latest view 620, only the most recent revision of each stream is shown. Thus, in this view, only the reversion revision of AJ and the revision that was shared with AJ by You are shown. In Milestone view 630, only milestone revisions are shown. A revision that has been nominated as final, sometimes referred to as a candidate final revision, may be treated as a milestone version, and thus made visible in the Milestone view 630. Once a candidate final revision is voted on and approved, only the approved final version appears in either the Latest view or the Milestone view. Each user has control over whether to mark a revision as a milestone.

Any revision in any of the views or visualization modes can be viewed by any user at any time. The user initiates viewing the revision by a double-click action on the icon, which opens that document revision in the authoring program 112, 122, 132, 162. In an alternative embodiment, a user may open the document revision in another viewing application capable of reading the specified document format. For example, a read-only viewer may be used for viewing the revision. If another revision of the document is currently open, the system 100 may automatically save and close the open revision before opening the selected revision in one embodiment. In another embodiment, the user may be prompted before saving the open revision. Opening a prior revision does not allow further edits to that revision; edits can only be made to the latest revision. If a user wishes to return to a prior document state, the user can do so using the Revert command. In one embodiment, a double-click or other predetermined selection technique may be used to select any of the revisions in a user's stream, opening that prior revision. The newly opened revision may then be marked as the currently open revision, even though it is not the latest revision.

Regardless of which revision is being viewed, in one embodiment the authoring or viewing program displaying the document indicates the document name without indicating the revisionID, so that editing the document always looks as if the same document is being edited, regardless of the revisionID.

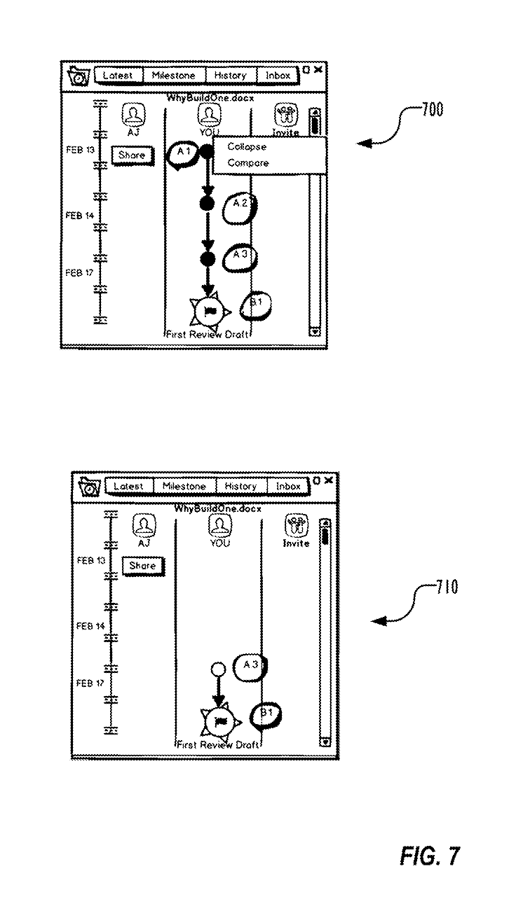

A stream of revisions may involve numerous minor revisions. In one embodiment, minor revisions displayed in the history of a stream may be collapsed to simplify the display by selecting a range of minor revisions and invoking the collapse function. This action does not delete the revisions but removes them from the display. The function does not collapse revisions that are parents to another user's revision or that is designated as a Milestone. The process can be reversed using the expand function. The user action survives sessions. FIG. 7 is a block diagram illustrating a stream display 700 before a collapse and stream display 710 after a collapse action having selected revisions A1 to A3. In one embodiment, after selecting the revisions to collapse, a right-click brings up a menu of actions including the collapse, which can be selected to collapse the selected range of revisions. The collapsed range removes all but the last of the minor revisions in the selected range from the display, as illustrated in stream display 710. If the range includes non-minor revisions, those will be retained in the collapsed display. Similarly, the collapsed revision A3 of stream display 710 can be expanded to its complete display state by right-clicking on the collapsed node A3 and selecting the Expand action.

Any two revisions in the document history can be directly compared at any time by any user. If the authoring program 112, 122, 132, 162 supports an internal comparison feature that highlights differences, such as Microsoft Word, the client software 114 may invoke the comparison function via plugin or API and automatically load the selected revisions in the correct sequence to display in the native comparison functionality. As an alternative, the client software 114 may invoke an external comparison engine capable of reading the specified document format to perform the same task, if not otherwise supported by the authoring program or if configured to use the external comparison engine instead of the feature of the authoring program 112, 122, 132, 162. The following diagrams illustrates the comparison function:

The combine revision operation works similarly to that of the comparison operation, except the combine operation results in the creation of a new document revision. The new revision is inserted into the stream of the user invoking the combine operation regardless of which document revisions are being combined. Thus, two different users may produce combination revisions of the exact same two prior document revisions, with the resulting combination revision placed in their respective stream. The two combined document revisions output could then be subsequently combined by any user. Combinations may be made from two revisions in a user's own stream, a revision in the user's stream and a revision in another user's stream, or two revisions in one or two other users' streams. If the authoring program 112, 122, 132, 162 supports an internal combination feature that highlights differences, allows a user to selectively accept changes, and produces a new document copy like Microsoft Word, the client software 114 may invoke the combination function via a plugin or API and automatically load the selected revisions in the correct sequence to operate the native functionality. As an alternative, the client software can invoke an external merging/difference engine capable of reading the specified document format to perform the same task, if not otherwise supported by the authoring program of if configured to use the external combination engine instead of the feature of the authoring program 112, 122, 132, 162.

In one embodiment, a combination that includes a revision that is actively being edited by one of the collaborators may be prohibited, even though opening that revision or comparing that revision with another revision may be allowed even while editing.

In some instances a user may wish to restore a prior revision of a document and continue editing from that prior state. The revert function promotes a prior revision in a user's stream as the current revision. This operation does not rollback the history of the stream, which remains completely intact including all revisions subsequent to the reverted revision and any relationships to those revisions. The revert function simply creates a new editable revision in the stream that matches the identified prior revision. An example of such a revision was discussed above in the discussion of FIG. 5. As with the collapse, expand, combine, and comparison functions, the revert functionality may be invoked by selecting a revision in a stream, indicating the revision function is desired, such as by right-clicking the revision to which reversion is desired.

Any revision that is significant to the user can be marked as a milestone revision. The milestone action freezes that revision such that any subsequent edits by that user must result in another revision, rather than a change to the milestone revision. In one embodiment, indicating a revision as a milestone produces an input area allowing a user to annotate the revision with a descriptive annotation, such as by opening a text input area for the user to enter the annotation. The annotation may be displayed in the document history display or may be temporarily displayed upon an action related to the revision, such as a mouse roll-over of the annotated revision. The milestone function may be useful for annotating specific revisions of interest to the other users in the system, such as draft or comment completion annotations.

Documents and revisions are only visible to the creating user until those revisions are shared with another user. After sharing, the original user may continue working on the document, generating revisions in the original user's stream of revisions, while the other user may begin working on the document in the other user's stream of revisions. One the document has been shared, in one embodiment the revisions of the original user and the revisions of the other user that are made after the sharing are visible to each other. In one embodiment, only the shared revision and revisions made after the sharing action are visible to the other user. In other embodiments, the entirety of both streams are visible to each other once sharing has occurred. In another embodiment, only the revisions specifically authorized, or, alternatively, not specifically excluded, by the sharing user would be visible to the other user, on a per-user basis. A user may share the document with any other user of the system 100, regardless of whether the other user is associated with the same business entity as the sharing user. In some embodiments, security policies may be established that limit or control the ability which users may login to the system 100 and collaborate on document revisions.

At any point in the editing process, any user can nominate a specific revision as a candidate for a final revision of the document. Once a revision has been designated as final, an annotation similar to the milestone annotation may be provided if desired, and no further edits to that revision are allowed. In a system 100 that employs a system of record 140, the final revision may be pushed to the system of record 140 for archiving or other processing as desired. In some embodiments, nominating a revision as final causes a voting action to be performed on whether to approve the document revision as final. Various voting arrangements may be implemented, including requiring a majority vote to approve, requiring unanimous approval, and allowing a unilateral decision by the user nominating the revision as final. In some embodiments, votes on a final nomination may be indicated next to the icon for the voter in row 510 of the display 500. In some embodiments, once finality is approved, previous revisions may be removed from the document history display 500, although the revisions may be preserved in the repository. In some embodiments, prior revisions may be deleted from the repository upon approval of a revision as final.

In one embodiment, a user wishing to use the revision system 100 described above may identify himself or herself to the system by a login functionality, which grants access to the hidden repository for that user. At login time, the user may specify one or more others that are collaborating with the user on the document, causing the system 100 to populate the document history display with lanes for those other people. Users that have been specified as collaborating on a document in prior sessions will be retained for each subsequent session of that document. Some embodiments may limit the number of collaborators to a predetermined maximum. A user interface may allow customization and configuration of the information provided in the document history display, including specifying information about the other users of the system 100, such as email addresses, pictures, etc.

In one embodiment, a user may remove another user from the document revision system 100. In such an event, the system 100 may delete all revisions from that user's stream from any repository that holds such revisions.

In one embodiment, messages may be sent to users in the system 100. The inbox button in area 565 of the display 500 may allow the user to view messages in the inbox for that user. These messages may include any desired messages, including inviting the user to collaborate in a group working on a document, messages that a user has shared document, voting messages, etc.

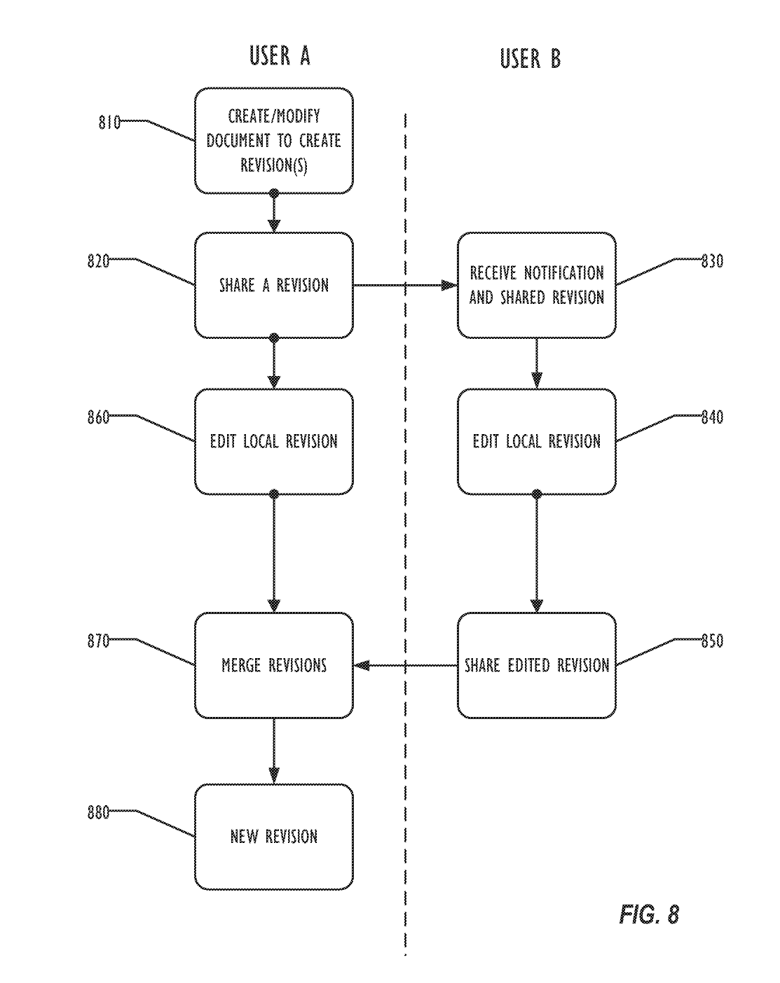

FIG. 8 is a graph illustrating a sequence of events related to sharing of a revision of a document. In block 810, user A creates a document or modifies a document to create a new revision of the document. In block 820, user A shares the revision with user B. In block 830, user B receives a notification that the document has been shared with user B, the document is stored in the hidden repository associates with user B, and made available for editing. In block 840, user B edits the document, creating a new revision. Meanwhile, in block 860, user A edits the document creating a new revision. In block 850, user B shares the latest user B revision of the document with user A, who merges the latest user A revision and user B revision into a single revision in block 870. Finally in block 880, user A creates a new revision based on the combined revision created in block 870.

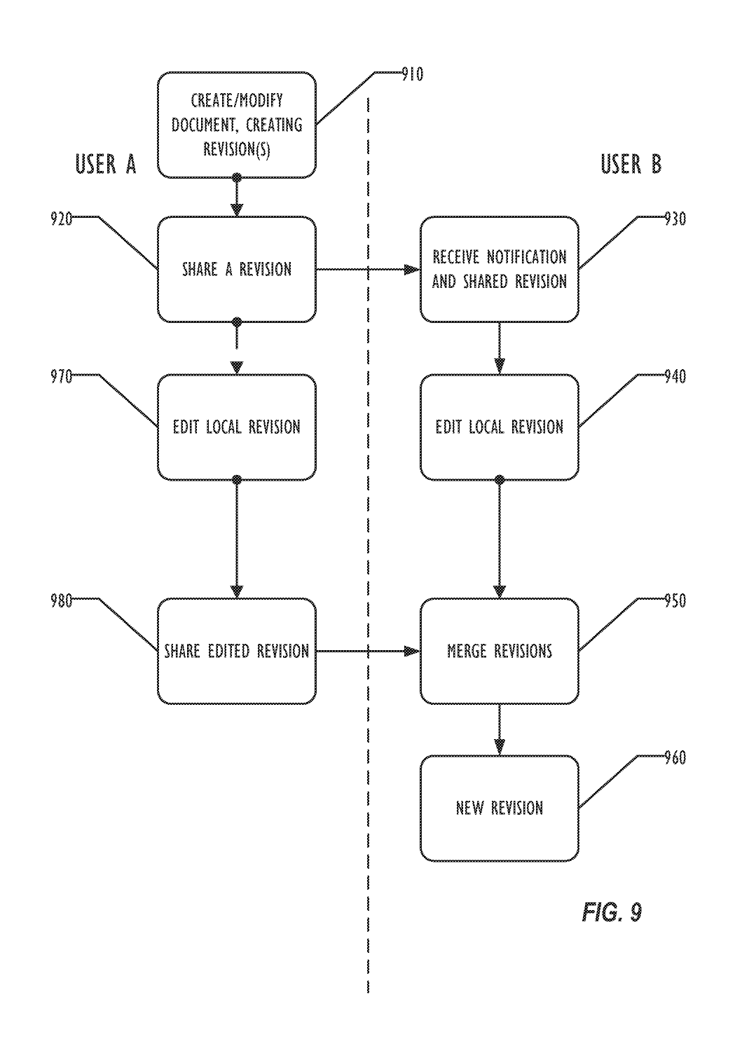

FIG. 9 is a similar graph, in which user A and user B collaborate on a document, in this example with user B doing the combination. In block 910, user A creates or modifies the document, creating one or more revisions. In block 920, user A shares the latest revision with user B, who accepts the shared revision in block 930. In blocks 940 and 970, users B and A, respectively, create new revisions in their respective document streams. Up to this point, FIG. 9 is identical to FIG. 8. But now, user A shares the latest user A revision with user B in block 980 and user B does the combining in block 950, finally creating a new revision based on the merged document in block 960.

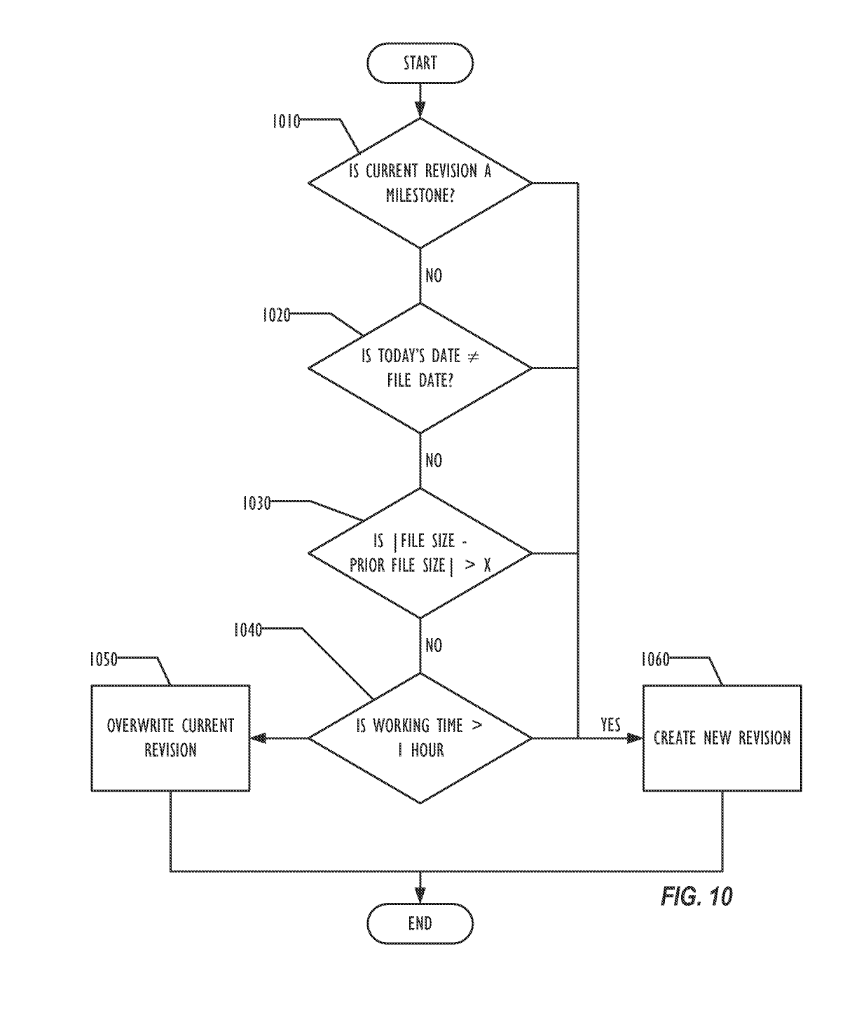

FIG. 10 is a flowchart illustrating one technique for determining whether to create a new revision or overwrite an existing revision when saving a document according to one embodiment. In block 1010, the status of the currently edited revision is determined. If the current revision is a milestone, then saving the currently edited revision produces a new revision in block 1060. If the currently edited revision is not a milestone, then in block 1020 the current date is compared to the date of the last save of the revision. If today's date is not the same as the date the revision was last saved, saving the revision produces a new revision. If the dates are the same, then in block 1030 the file sizes are compared to see if they differ by over a predetermined threshold. If so, then saving creates a new revision in block 1060. Finally, in block 1040, a current editing time of the document is compared to a predetermined threshold, in this example 1 hour. If editing has been going on for more than the threshold time, then in 1060 the document is saved as a new revision. Otherwise, the current revision is overwritten without creating a new revision.

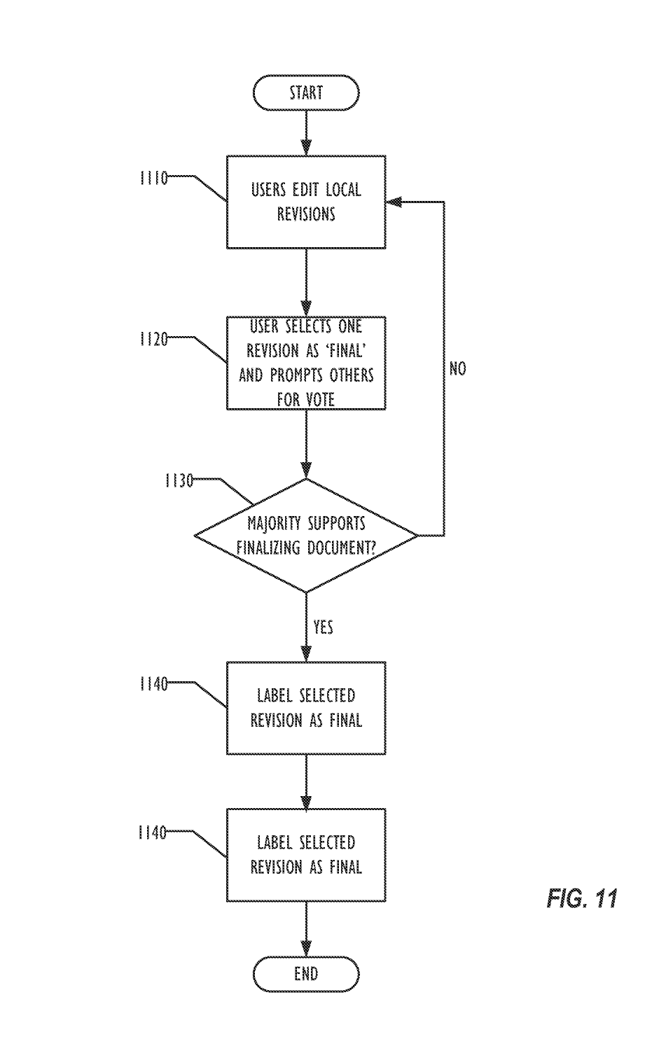

FIG. 11 is a flowchart illustrating a technique for voting on whether to mark a revision as a final revision according to one embodiment. In block 1110, users edit the document, creating their respective revisions. In block 1120 a user nominates a revision as final, and requests the other collaborating users to vote on their approval of designating the revision as final. The other users may then review the revision and indicate their vote. In this example, if a majority vote approves finalizing the document in block 1130, then the revision is labeled as final in block 1140. Otherwise, users may continue to edit the document and produce revisions. When the revision is approved as final in block 1140, and a system of record 140 is in use, the final revision may be pushed to the system of record for archiving.

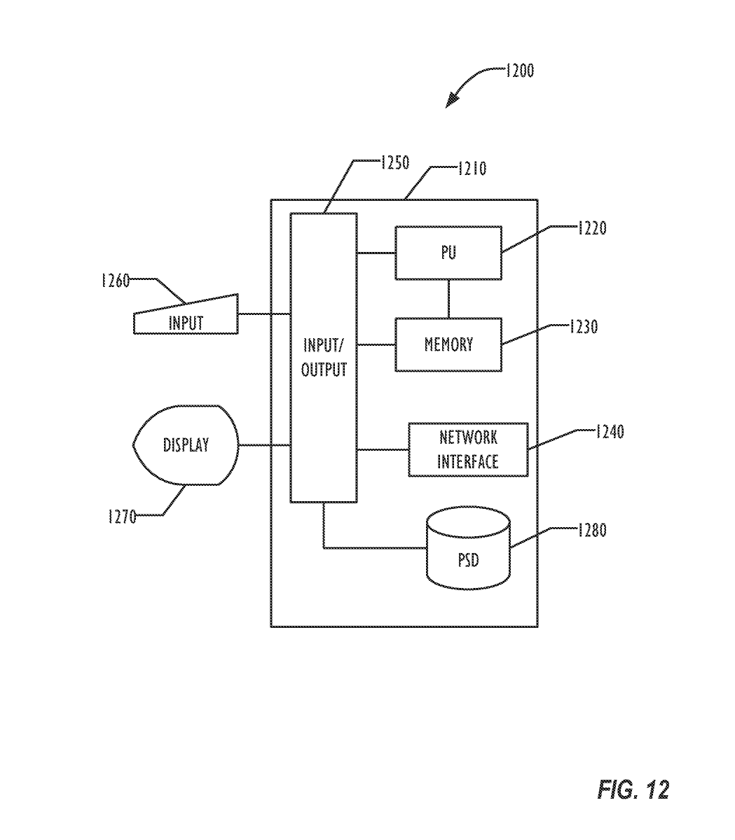

FIG. 12 is a block diagram illustrating a programmable device 1200 that may be used for implementing the techniques described above. The example programmable device 1200 may be used for the client devices 110, 120, 130, and 160, web service 150, and system of record 140. Example programmable device 1200 comprises a system unit 1210 which may be optionally connected to an input device or system 1260 (e.g., keyboard, mouse, touch screen, etc.) and display 1270. A program storage device (PSD) 1280 (sometimes referred to as a hard disc) is included with the system unit 1210. Also included with system unit 1210 is a network interface 1240 for communication via a network with other computing and corporate infrastructure devices (not shown). Network interface 1240 may be included within system unit 1210 or be external to system unit 1210. In either case, system unit 1210 is be communicatively coupled to network interface 1240. Program storage device 1280 represents any form of non-volatile storage including, but not limited to, all forms of optical and magnetic, including solid-state, storage elements, including removable media, and may be included within system unit 1210 or be external to system unit 1210. Program storage device 1280 may be used for storage of software to control system unit 1210, data for use by the computer 1200, or both.

System unit 1210 may be programmed to perform techniques in accordance with this disclosure as described above. System unit 1210 comprises a processor unit (PU) 1220, input-output (I/O) interface 1250 and memory 1230. Processing unit 1220 may include any programmable controller device including one or more members of the processor families in common use in computers, including multi-core processors. Memory 1230 may include one or more memory modules and comprise random access memory (RAM), read only memory (ROM), programmable read only memory (PROM), programmable read-write memory, and solid-state memory. One of ordinary skill in the art will also recognize that PU 1220 may also include some internal memory including, for example, cache memory. Software that when executed causes the programmable device to perform the functionality described above may be provided on one or more machine readable media. The internal organization and functioning of the programmable device 700 is outside the scope of this disclosure and the structure of FIG. 12 is illustrative and by way of example only.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

We claim:

1. A machine-readable medium on which are stored instructions, comprising instructions that when executed, cause a programmable device to:
store a first sequence of revisions of a document by a first user in a first repository associated with the first user;
share a revision of the first sequence of revisions with a second user by copying the revision to a second repository associated with the second user;
store additional revisions by the first user in the first sequence of revisions of the document in the first repository;
store new revisions by the second user in a second sequence of revisions of the document, independent of the first sequence in the second repository;
select a first revision of the first sequence of revisions and a second revision of the second sequence of revisions;
merge the first revision with the second revision into a third revision; and
store the third revision as one of the first sequence of revisions or the second sequence of revisions.

2. The machine-readable medium of claim 1, further comprising instructions that when executed cause the programmable device to:
display the first sequence of revisions and the second sequence of revisions in a customizable document history display.

3. The machine-readable medium of claim 2, wherein the instructions to display the first sequence of revisions and the second sequence of revisions comprise instructions to collapse a display of a selected range of revisions into a display of a latest revision in the range of revisions.

4. The machine-readable medium of claim 3, wherein the instructions to display the first sequence of revisions and the second sequence of revisions comprise instructions to expand a display of a latest revision in a previously collapsed display into a display of the selected range of revisions.

5. The machine-readable medium of claim 1, wherein the first repository and the second repository are not user visible.

6. The machine-readable medium of claim 1, wherein the first repository and the second repository are synchronized with each other.

7. The machine-readable medium of claim 1, wherein the first repository and the second repository are synchronized with each other and a global repository.

8. The machine-readable medium of claim 1, further comprising instructions that when executed cause the programmable device to:
cause an application to compare two revisions of the document.

9. The machine-readable medium of claim 1, further comprising instructions that when executed cause the programmable device to:
revert the document to a previous revision by creating a new revision that is a copy of the previous revision.

10. The machine-readable medium of claim 1, further comprising instructions that when executed cause the programmable device to:
nominate a revision as potentially final;
hold a vote among users sharing the document; and
finalize the revision responsive to the vote meeting a predetermined criterion.

11. The machine-readable medium of claim 10, wherein the predetermined criterion comprises a majority of votes cast.

12. The machine-readable medium of claim 1, further comprising instructions that when executed cause the programmable device to:
mark a selected revision as a milestone.

13. A collaborative editing system, comprising:
a programmable processor;
a data repository, coupled to the processor and configured to store documents edited in the collaborative editing system; and
a memory, coupled to the programmable processor, on which are stored instructions that when executed cause the programmable processor to:
store revisions of the document in the data repository;
maintain a separate stream of revisions for each person editing the document; and
synchronize the data repository with client data repositories associated with each person editing the document.

14. The collaborative editing system of claim 13, wherein the instructions further comprise instructions that when executed cause the programmable processor to:
copy revisions having a predetermined status to an archival storage system.

15. A method of collaboratively editing a document, comprising:
detecting a document in a predefined document location;
copying the document into a first repository of revisions to the document associated with a first user;
saving edited copies of the document as revisions in the first repository of revisions;
sending a revision of the document to second repository of revisions to share the document with a second user; and
displaying a first indicator of a first stream of revisions in the first repository and a second indicator of a second stream of revisions in the second repository.

16. The method of claim 15, further comprising:
selecting a first revision of the first stream of revisions and a second revision of the second stream of revisions;
combining the first revision and the second revision, producing a combined revision; and
updating the document in the predefined document location to correspond to the combined revision.

17. The method of claim 15, further comprising:
selecting a range of revisions in the first stream of revisions; and
collapsing the first indicator of the first stream of revisions so that only a latest revision of the range of revisions is displayed.

18. The method of claim 15, further comprising:
sending an invitation to join the collaborative editing system.

19. The method of claim 15, further comprising:
selecting a first revision other than a latest revision of the first stream of revisions;
updating the document in the predefined document location to correspond to the first revision; and
creating a new revision in the first stream of revisions from the first revision as the latest revision of the first stream of revisions.

20. The method of claim 15, further comprising:
synchronizing the first repository of revisions with a global repository of revisions.
